(19) United States
(12) Patent Application Publication
(10) Pub. No.: US 2015/0050232 A1
(43) Pub. Date: Feb. 19, 2015

(54) MARINE ANTIFOULING COATING

(71) Applicant: LION COPOLYMER GEISMAR, LLC, Geismar, LA (US)

(72) Inventors: Zhiyong Zhu, Baton Rouge, LA (US); Harold William Young, JR., Baton Rouge, LA (US)

(21) Appl. No.: 14/529,523

(22) Filed: Oct. 31, 2014

Related U.S. Application Data
(63) Continuation-in-part of application No. 14/179,474, filed on Feb. 12, 2014, now Pat. No. 8,901,195.
Application No. 14/179,474 is a continuation-in-part of application No. 14/179,482, filed on Feb. 12, 2014.
Application No. 14/179,482 is a continuation-in-part of application No. 14/228,163, filed on Mar. 27, 2014.
(60) Provisional application No. 61/764,471, filed on Feb. 13, 2013.
(60) Provisional application No. 61/765,479, filed on Feb. 15, 2013.
(60) Provisional application No. 61/764,483, filed on Feb. 13, 2013.
(60) Provisional application No. 61/764,471, filed on Feb. 13, 2013.
(60) Provisional application No. 61/765,479, filed on Feb. 15, 2013.
(60) Provisional application No. 61/764,483, filed on Feb. 13, 2013.
(60) Provisional application No. 61/829,961, filed on May 31, 2013.
(60) Provisional application No. 61/829,971, filed on May 31, 2013.
(60) Provisional application No. 61/829,975, filed on May 31, 2013.

(51) Int. Cl. C09D 5/16

(52) U.S. Cl. CPC C09D 5/1668; C09D 5/1687
USPC 424/78.09

(57) ABSTRACT

A marine antifouling coating comprising a hydrophobic polymeric material formed by reacting a mixture comprising at least one ethylene propylene diene terpolymer, wherein the terpolymer component comprises from 4 weight percent to 50 weight percent of random covalently linked monomers of ethylene and propylene and 0.25 weight percent to 15 weight percent of the polymer component is a non-conjugated diene, a first co-agent of polybutadiene, a second co-agent of an acrylate or methacrylate in a solvent with at least one peroxide. The marine antifouling coating is used for application to a surface of a marine vessel.

### CROSS REFERENCE TO RELATED APPLICATIONS

The present application is a Continuation in Part of co-pending U.S. patent application Ser. No.: 14/179,474 filed on Feb. 12, 2014, entitled “METHOD FOR MAKING A HIGH SOLIDS LOW VOLATILE ORGANIC COMPOUNDS CONTENT ETHYLENE TERPOLYMER DIENE RUBBER COATING”; and co-pending U.S. patent application Ser. No.: 14/179,482 filed on Feb. 12, 2014, entitled “HIGH SOLIDS LOW VOLATILE ORGANIC COMPOUNDS CONTENT ETHYLENE TERPOLYMER DIENE RUBBER COATING”; which both claim priority to and the benefit of U.S. Provisional Patent Application Ser. No.: 61/764,471 filed on Feb. 13, 2013, entitled “AMBIENT LIGHT CURABLE ETHYLENE PROPYLENE DIENE MONOMER RUBBER COATING DEVOID OF THERMALLY ACTIVATED ACCELERATORS”; U.S. Provisional Patent Application Ser. No.: 61/764,479 filed on Feb. 13, 2013, entitled “DUAL CURABLE ETHYLENE PROPYLENE DIENE MONOMER RUBBER COATING USING A PHOTOINITIATOR AND A PEROXIDE”; and U.S. Provisional Patent Application Ser. No.: 61/764,483 filed on Feb. 13, 2013, entitled “HIGH SOLIDS LOW VOC CONTENT ETHYLENE PROPYLENE DIENE RUBBER COATING”; and is a Continuation in Part of co-pending U.S. patent application Ser. No.: 14/228,163 filed on Mar. 27, 2014, entitled “HIGH SOLIDS CROSS-LINKED ETHYLENE PROPYLENE DIENE TERPOLYMER LATEX”; which claims priority to and the benefit of U.S. Provisional Patent Application Ser. No.: 61/829,961 filed on May 31, 2013, entitled “METHOD FOR MAKING A HIGH SOLIDS CROSS-LINKED ETHYLENE PROPYLENE DIENE MONOMER LATEX”; U.S. Provisional Patent Application Ser. No.: 61/829,971 filed on May 31, 2013, entitled “HIGH SOLIDS CROSS-LINKED ETHYLENE PROPYLENE DIENE MONOMER LATEX”; and U.S. Provisional Patent Application Ser. No.: 61/829,975 filed on May 31, 2013, entitled “CROSS-LINKED ETHYLENE PROPYLENE DIENE LATEX BLENDS FOR IMPROVED COATINGS”. These references are hereby incorporated in their entirety.

### FIELD

The present embodiments generally relate to a two part marine coating having a hydrophobic polymer of an ethylene propylene diene terpolymer rubber that is consumer friendly to use and can be used below and above the water surface.

### BACKGROUND

A need exists for a two part marine coating that requires no additional heat for curing.

A further need exists for a two part ethylene propylene diene terpolymer (EPDM) waterproof rubber coating formed from a liquid that does not require isocyanates or other toxic chemicals.

A further need exists for a marine coating that does not require a biocide to prevent attachment of marine organisms on the coating surface.

The present embodiments meet these needs.

### DETAILED DESCRIPTION OF THE EMBODIMENTS

Before explaining the present invention in detail, it is to be understood that the invention is not limited to the particular embodiments and that it can be practiced or carried out in various ways.

A benefit of the formulation is that the formulation avoids formation of pinholes in the coating.

A benefit of the formulation is that the coating has uniform coverage, good adhesion with steel.

A special advantage of the rubber formulation is the likelihood of reduced cracking of the coating over time.

An advantage of the coating is that the rubber can be visually inspected easily by an untrained naval person.

The formulation has at least a 35 minute to 45 minute pot life, and in certain cases, a pot life of up to 2 hours to 4 hours.

The surface energy of the unique formulation can be designed to be within 18 dynes per centimeter to 30 dynes per centimeter for the final cured coating.

The formulation can readily incorporate pigments such as white, carbon black, or grey.

The formulation can be used under water as well as above water. The formulation can be used on bridges like the Golden Gate Bridge and oil rigs like BULLWINKLE™. The formulation can be used on water pipes, material in tunnels, metal, concrete, wind turbines such as on offshore wind farms, and dam equipment, such as components of the Hoover Dam.

In embodiments, combinations of blue pigment, red pigment and other low solar absorbing pigments should be usable in the formulation, providing covalent bonds to components of the non-conjugated diene enabling the formulation to hold pigment color more effectively without fading to pink in only 12 months.

The formulation can be modified to form either a dull coating or shiny coating depending on additives included in the formation.

According to ASTM method D-523-14, the coating created by the formulation can be configured to produce a reflectance in gloss units as much as 70 percent down to 30 percent of the incidence light at the surface. A coating created by the formulation with high gloss units, (50 percent-70 percent) is particularly usable on Coast Guard vessels that require high gloss.

The present embodiments relate to a two part heat free curable ethylene propylene diene terpolymer rubber formulation that is consumer friendly to use.

The invention relates to a marine antifouling coating for application to a surface of a marine vessel.

A hydrophobic polymeric material is formed by reacting a mixture of: an ethylene propylene diene terpolymer (EPDM); the EPDM having with a molecular weight from 1,300,000 Mw to 5000 Mw, formed of 4 weight percent to 50 weight percent of random covalently linked monomers of ethylene and propylene having weight ratios from 40:60 to 85:15 of ethylene:propylene respectively; and 0.25 weight percent to 15 weight percent of the polymer component is a non-conjugated diene; blended with a first co-agent of polybutadiene; and a second co-agent of an acrylate in a solvent or methacrylate in a solvent. The mixture is then reacted with at least one peroxide applied to a surface and allowed to cure.

A benefit of the marine antifouling coating is that when the mixture is reacted with the peroxide, the applied formulation cures at ambient temperatures without the need to add heat.

A benefit of the formulation is that when the liquid EPDM mixture is blended with the peroxide, the combination is easy to apply in the field with a brush, spray, or roller, and no extra liquid is needed.

A benefit of the invention is that users of the liquid EPDM formulation produced from the method will avoid the possibility of having second or third degree burns from applying the two part formulation, because the coating is “heat free” to cure on a substrate or a marine vessel.

The invention relates to a substrate with a surface comprising the cured marine antifouling coating made from the hydrophobic polymeric material, to extend the life of the substrate, such as vessel reducing the need for repainting and pressure washing of the vessel.

In other embodiments, the formulation can be used to seal docks for marinas.

In embodiments, the invention relates to a maritime vessel having the hydrophobic polymeric material coated on the hull and superstructure.

Another benefit of the two part liquid rubber coating is that the two parts are each stable in its packaging system for delivery to a user.

The following terms are used herein:

The term “additive” as used herein can refer to an antioxidant, an ultraviolet light stabilizer, or combinations thereof.

The term “adhesion promoter” as used herein can refer to a component made from molecules that tie the formed EPDM coating to a substrate for enhanced bonding. An example of an adhesion promoter can be SARET® 633 or 634 made by Arkema France.

The term “ambient temperature” as used herein can refer to a temperature less than 50 degrees Celsius and equal to or greater than −10 degrees Celsius.

The term “antioxidant” can refer to a hindered phenolic stabilizer, such as IRGANOX® 1076 made by Ciba Specialty Chemicals Corporation of Tarrytown, N.Y.

The term “anti-settling agent” as used herein can refer to an agent that prevents the settling of pigments and fillers in the mixture. An example of a usable anti-settling agent can be M-P-A® made by Elementis Specialties, Inc. of Hightstown, N.J. Another example is a hydroxyethyl cellulose. Still another example is a fumed silica.

The term “co-agent” as the term is used herein can refer to a reactive molecule with two or more functional groups, for bonding with an EPDM molecule. The co-agent can enhance crosslinking between two EPDM molecules initiated by a peroxide. The term “enhances” can refer to an accelerated process of crosslinking. Co-agents accelerate reaction of the free radicals with the active sites of the unsaturated diene to cross link the terpolymer.

Usable co-agents can include an acrylate, methacrylate, and polybutadienes. For example, usable co-agents can be hexane diol diacrylate, polybutadiene, a triallyl cyanurate, and phenylenedimaleimide known as VAMAC® DP HVA-2 available from E.I. DuPont of Wilmington, Del.

The term “molecular weight” for the polymer as used herein can refer to a weight average molecular weight as determined by gel permeation chromatography (GPC) measurement.

The term “pigment dispersant” can refer to a chemical that allows pigment to remain homogenously dispersed in the mixture. Examples of usable pigment dispersants include NUOSPERSE® 9100 available from Elementis Specialties, Inc.

The term “plant-based solvent” can refer to vegetable based, grass based, weed based, nut based, or food based solvents including but not limited to methyl soyate.

The term “terpolymer” as used herein can refer to a polymer of ethylene, propylene, and one or more non-conjugated dienes. Examples of non-conjugated dienes usable herein can include norbornene, ethylidene norbornene, 1,4, hexadiene, dicyclopentadiene, vinyl norbornene, methylene norbornene, and combinations thereof.

In other embodiments, the terpolymer of ethylene, propylene and one or more non-conjugated dienes can have the propylene replaced by another alpha olefin, such as but not limited to 1-butene, 1-pentene, 1-hexene, 1-heptene, 1-octene, or combinations thereof.

In embodiments, the “polymer” can be ethylene propylene polymer, ethylene butene polymer, ethylene pentene polymer, or combinations thereof.

“Solvents” as the term is used herein can refer to an aliphatic solvent, an aromatic solvent, or a plant based solvent with a density from 0.6 to 1.2 grams per cubic centimeter. Examples of usable solvents include mineral spirits, toluene, hexane, xylene, hexamethyldi-siloxane, or combinations thereof.

The term “waterproof” as used herein can refer to a moisture vapor permeation rating of less than 1.

The term “wetting agent” can refer to chemicals such as DISPONER™ 983 available from Elementis Specialties, Inc. A wetting agent improves the wetting performance creating a glossy surface for the final coating.

Wetting agents can include silicone polyacrylate copolymer in solvents such as BYK®-3550 or a solvent-free polyether modified dimethylpolysiloxane such as BYK®-378 made by BYK-Chemie GmbH of Germany.

The novel invention when the mixture is blended with the peroxide can be coated onto various substrates including ships, and boats. Substrates that are usable can include decks, cabin roofs, metal, glass, docks, concrete, polyurethane foam, acrylate material system, wood, offshore oil platforms, offshore floating structures and terminals and the like.

The formulation has two parts, a rubber mixture and a peroxide.

The rubber mixture includes an ethylene propylene diene terpolymer component.

The ethylene propylene diene terpolymer “EPDM” refers to ethylene propylene diene terpolymers. These EPDM have no double bonds in the backbone of the polymer chains and, thus, are less sensitive to oxygen and ozone and have high UV-resistance. In EPDM, the ethylene and propylene comonomers form a saturated polymer backbone with randomly distributed, non-conjugated diene monomers, which provide unsaturations attached to the main chain.

The premixed terpolymer component has a molecular weight from 1300000 Da to 5000 Da.

The premixed terpolymer component has 4 weight percent to 50 weight percent of random covalently linked monomers of ethylene and propylene having weight ratios from 40:60 to 85:15 of ethylene:propylene respectively.

The premixed terpolymer component has 0.25 weight percent to 15 weight percent of the polymer component is a non-conjugated diene.

This pure EPDM component can contain 4 weight percent to 50 weight percent of dry ethylene/propylene polymers with molecular weights from 10000 Da to 600000 Da are also considered useful herein. Molecular weights that are from 5000 Da to 80000 Da are also useful.

The polymer has random covalently linked monomers of ethylene and propylene covalently connected to diene.

The non-conjugated diene has at least one of methylidene norbornene, dicyclopentadiene, ethylidene norbornene, and 1,4-hexadiene, vinyl norbornene.

The ethylene propylene diene terpolymer is mixed with a first co-agent of polybutadiene and a second co-agent of an acrylate or methacrylate and a solvent.

This combination of components forms the mixture which is then blended with the peroxide forming the marine coating for application to the substrate or marine vessel.

The invention relates to a marine antifouling coating of the invention to prevent the settlement of marine organisms on a surface and/or prevents the growth of marine organisms on a surface and/or encourages the dislodgement of marine organisms from a surface.

The hydrophobic polymeric material is formed when the mixture having the ethylene propylene diene terpolymer component is mixed with the peroxide.

The mixture is formed from 25 weight percent to 80 weight percent based on the total weight of the mixture of an ethylene propylene diene terpolymer component. The terpolymer component having a molecular weight from 1300000 Da to 5000 Da, with 4 weight percent to 50 weight percent of random covalently linked monomers of ethylene and propylene having weight ratios from 40:60 to 85:15 of ethylene:propylene respectively; and 0.25 weight percent to 15 weight percent of the polymer component is a non-conjugated diene.

The mixture includes 1 weight percent to 10 weight percent of a first co-agent comprising polybutadiene, such as RINCON 156 wherein the weight percent of the co-agent is based on a total weight of the mixture. The polybutadiene is a branched or linear polymer having a molecular weight between 1000 and 10000.

The mixture includes 1 weight percent to 10 weight percent of second co-agent comprising which is one or more of an acrylate co-agent having the molecular formula CH₂═CHCOOH, or having the molecular formula CH₂═CHCOOR, wherein R is an alkyl group; and a methacrylate co-agent having the molecular formula (CH₂═C(CH₃)CO₂H), having the molecular formula CH₂═C(CH₃)CO₂R, wherein R is an alkyl group.

Each second co-agent has at least 2 acrylate groups, such as between 2 and 3 acrylate groups or at least 2 methacrylate groups, such as 2 and 3 methacrylate groups. A co-agent that is usable herein is SR 350 available from Sartomer.

The mixture includes 1.0 weight percent to 55 weight percent of a solvent based on the total weight of the mixture.

The solvent can be at least one of: an aliphatic solvent, an aromatic solvent, and a plant-based solvent. In the mixture, the first and second co-agents chemically bond to the ethylene propylene diene terpolymer (EPDM).

For use in the field, the mixture is reacted with 1 weight percent to 5 weight percent of a peroxide.

More specifically, 30 weight percent to 100 weight percent of a peroxide is used. The peroxide is selected from the group peroxyketal, a peroxyester, a dialkyl peroxide, a peroxy carbonate, and a hydro peroxide. A solvent can be combined with the peroxide when less than 100 percent peroxide is used.

When the mixture is blended with the peroxide, a hydrophobic polymeric marine antifouling coating is formed that has a surface energy to prevent the settlement of marine organisms on a surface and/or prevent the growth of marine organisms on a surface and/or encourage the dislodgement of marine organisms from the surface.

In embodiments, the hydrophobic polymeric marine antifouling coating once cured, has a tensile strength greater than 3.0 MegaPascal, an elongation at break from 50 percent to 200 percent, a surface energy of 18 dyne per centimeter to 30 dyne per centimeter, a scratch resistance that can tolerate 500 grams of weight without surface damage, and an adhesion to metal and epoxy substrates with a lifetime of at least 1 year.

The marine antifouling coating can further include 1 weight percent to 30 weight percent of a pigment based on a total weight of the hydrophobic polymeric material.

The pigment can be combinations of low solar absorbing pigments, such as red, blue and white. Titanium dioxide or iron oxide can be used. The pigment can be carbon black.

The formulation can include 0.1 weight percent to 5 weight percent of a pigment dispersant based on the total weight of the hydrophobic polymeric material In embodiments, the pigment dispersant can be 1 methoxy-2-propylacetate.

The marine antifouling coating can include 1 weight percent to 30 weight percent of a filler based on a total weight of the hydrophobic polymeric material.

Filler can be silica, talc, clay, calcium carbonate or combinations. Similar fillers can be used. ULTREX® 96 from BASF, or COUPSIL® 6508 from Evonix are usable fillers.

The marine antifouling coating can include 0.1 weight percent to 5 weight percent of a metal drier based on the total weight of the hydrophobic polymeric material the metal drier is at least one of: a metal carboxylate and a metal alkoxide.

Metal drier is at least one of a metal carboxylate or an alkoxide. As an example, 12 percent Cobalt Ten-Cem available from OMG can be used, or 18 percent of zinc Ten-Cem can be used as the metal drier.

The marine antifouling coating can include 0.1 weight percent to 5 weight percent of an adhesion promoter based on the total weight of the hydrophobic polymeric material.

Adhesion Promoters which are usable include SARET® 633 available from Arkema.

In embodiments, the adhesion promoter can be a zinc diacrylate or zinc dimethacrylate.

The marine antifouling coating can include 0.1 weight percent to 5 weight percent of an anti-settling agent on the total weight of the hydrophobic polymeric material.

Anti-settling agent can be M-P-A® made by Elementis.

The marine antifouling coating can include 0.1 weight percent to 5 weight percent of a wetting agent on the total weight of the hydrophobic polymeric material.

In embodiments, the anti-settling agent can be a hydroxyl ethyl cellulose and a fumed silica.

A usable wetting agent is DISPONER™ 983 available from Elementis.

In embodiments, the wetting agent can be a silicone polyacrylate copolymer in solvent and a solvent-free polyether modified dimethylpolysiloxane.

The marine antifouling coating can include a solvent is selected from the group: mineral spirits and hexamethyldi-siloxane.

The following procedure relates the method for making the marine coating.

For the first part of the method mix ethylene propylene diene terpolymer (EPDM) with a solvent.

Add the first co-agent to the ethylene propylene diene terpolymer (EPDM) with solvent.

Add the second co-agent to the ethylene propylene diene terpolymer (EPDM) with solvent and first co-agent.

Next, the components can be mixed 30 minutes to 3 hours to form a smooth homogenous mixture. This mixture can then be packaged. In a second vessel the peroxide can be packaged.

To form the coating for application to a marine vessel, the peroxide is blended with the mixture quickly. A pot life of 30 minutes to 3 hours is formed for application of the peroxide with mixture blend. The coating self-cures once applied in 2 to 4 hours.

All of the EPDM is thoroughly mixed forming a smooth viscous mixture. Typically the viscosity should be from 1,000 centipoise to 20,000 centipoise.

In embodiments, a pigment can be added to the mixture of EPDM with solvent and both co-agents.

In embodiments the pigment dispersant can be added to the mixture of EPDM with solvent and both co-agents before a pigment is added to the mixture.

In embodiments, a filler can be added to the mixture made of EPDM with solvent and both co-agents.

In embodiments, a metal drier can be added to the mixture of EPDM with solvent and both co-agents prior to adding any pigment, pigment dispersant or filler.

In embodiments, adhesion promoter can be added to the mixture of EPDM with solvent and both co-agents prior to adding any pigment, pigment dispersant, filler or metal drier.

In embodiments, an anti-settling agent can be added to the mixture of EPDM with solvent and both co-agents prior to adding any pigment, pigment dispersant, filler or metal drier.

In embodiments, a wetting agent can be added to the mixture of EPDM with solvent and both co-agents prior to adding any pigment, pigment dispersant, filler, metal drier or antisettling agent.

The following tables represent formulations which can be created with this invention.

### Example 1

Example 1

| | |
|---|---|
| Component | % |

Part A

| | | |
|---|---|---|
| Polymer | Trilene ® T65 | 33 |
| Co-agent | Ricon ® 156 | 2.2 |
| Co-agent | SR-350 | 1 |
| Solvent | Mineral Spirit | 20 |
| Solvent | SIH6115.0 | 10 |
| Dispersant | Disper BYK ® 118 | 1 |
| White Pigment | Ti-Pure ® R-706 | 8.9 |
| Filler | Ultrex ® 96 | 16.5 |
| Metal Drier | 12% Co Ten-Cem | 0.25 |
| Metal Drier | 18% Zn Ten-Cem | 0.25 |

Part B

| | | |
|---|---|---|
| Peroxide | Peroxan ® PPIN | 1.9 |
| Solvent | Mineral Spirits | 5 |
| | Total | 100.00 |

### Example 2

Example 2

| | |
|---|---|
| Component | % |

Part A

| | | |
|---|---|---|
| Polymer | Trilene ® T65 | 33 |
| Co-agent | Ricon ® 156 | 2.2 |
| Co-agent | SR-350 | 1 |
| Solvent | Mineral Spirits | 30 |
| Pigment Dispersant | Disper BYK ® 118 | 1 |
| White Pigment | Ti-Pure ® R-706 | 8.9 |
| Filler | Ultrex ® 96 | 16.5 |
| Metal Drier | 12% Co Ten-Cem | 0.25 |
| Metal Drier | 18% Zn Ten-Cem | 0.25 |

Part B

| | | |
|---|---|---|
| Peroxide | Peroxan ® PPIN | 1.9 |
| Solvent | Mineral Spirit | 5 |
| | Total | 100.00 |

### Example 3—Red Pigment

Example 3

| | |
|---|---|
| Component | % |

Part A

| | | |
|---|---|---|
| Polymer | Trilene ® T65 | 33 |
| Co-agent | Ricon ® 156 | 2.2 |
| Co-agent | SR-350 | 1 |
| Solvent | Mineral Spirit | 30 |
| Pigment Dispersant | Disper BYK ® 118 | 1 |
| Red Pigment | PGRED001 | 8.9 |
| Filler | Ultrex ® 96 | 16.5 |
| Metal Drier | 12% Co Ten-Cem | 0.25 |
| Metal Drier | 18% Zn Ten-Cem | 0.25 |

Part B

| | | |
|---|---|---|
| Peroxide | Peroxan ® PPIN | 1.9 |
| Solvent | Mineral Spirit | 5 |
| | Total | 100.00 |

### Example 4

Example 4

| | |
|---|---|
| Component | % |

Part A

| | | |
|---|---|---|
| Polymer | Trilene ® T65 | 33 |
| Co-agent | Ricon ® 156 | 2.2 |
| Co-agent | SR-350 | 1 |
| Solvent | Mineral Spirit | 34.5 |
| Pigment Dispersant | Disper BYK ® 118 | 1 |
| Red Pigment | PGRED001 | 8.9 |
| Filler | Coupsil ® 6508 | 12 |
| Metal Drier | 12% Co Ten-Cem | 0.25 |
| Metal Drier | 18% Zn Ten-Cem | 0.25 |

Part B

| | | |
|---|---|---|
| Peroxide | Peroxan ® PPIN | 1.9 |
| Solvent | Mineral Spirit | 5 |
| | Total | 100.00 |

### Example 5

Example 5

| | |
|---|---|
| Component | % |

Part A

| | | |
|---|---|---|
| Polymer | Trilene ® T65 | 33 |
| Co-agent | Ricon ® 156 | 2.2 |
| Co-agent | SR-350 | 1 |
| Solvent | Mineral Spirit | 32.9 |
| Pigment Dispersant | Disper BYK ® 118 | 1 |
| White Pigment | Ti-Pure ® R-706 | 8.9 |
| Filler | Ultrex ® 96 | 16.5 |
| Metal Drier | 12% Co Ten-Cem | 0.25 |
| Metal Drier | 18% Zn Ten-Cem | 0.25 |

Part B

| | | |
|---|---|---|
| Peroxide | Peroxan ® PPO | 2 |
| Solvent | Mineral Spirit | 2 |
| | Total | 100.00 |

### Example 6

Example 6

| | |
|---|---|
| Component | % |

Part A

| | | |
|---|---|---|
| Polymer | Trilene ® T65 | 33 |
| Co-agent | Ricon ® 156 | 2.2 |
| Co-agent | SR-350 | 1 |
| Solvent | Mineral Spirit | 31.9 |
| Pigment Dispersant | Disper BYK ® 118 | 1 |
| White Pigment | Ti-Pure ® R-706 | 8.9 |
| Filler | Ultrex ® 96 | 16.5 |
| Metal Drier | 12% Co Ten-Cem | 0.25 |
| Metal Drier | 18% Zn Ten-Cem | 0.25 |

Part B

| | | |
|---|---|---|
| Peroxide | Peroxan ® TBPB | 5 |
| | Total | 100.00 |

### Example 7

Example 7

| | |
|---|---|
| Component | % |

Part A

| | | |
|---|---|---|
| Polymer | Trilene ® T65 | 25 |
| Co-agent | Ricon ® 156 | 5 |
| Co-agent | SR-350 | 5 |
| Solvent | Mineral Spirit | 23.8 |
| Pigment Dispersant | Disper BYK ® 118 | 5 |
| White Pigment | Ti-Pure ® R-706 | 5 |
| Filler | Ultrex ® 96 | 30 |
| Metal Drier | 12% Co Ten-Cem | 0.1 |
| Metal Drier | 18% Zn Ten-Cem | 0.1 |

Part B

| | | |
|---|---|---|
| Peroxide | Peroxan ® PPIN | 1 |
| | Total | 100.00 |

### Example 8

Example 8

| | |
|---|---|
| Component | % |

Part A

| | | |
|---|---|---|
| Polymer | Trilene ® T65 | 50 |
| Co-agent | Ricon ® 156 | 10 |
| Co-agent | SR-350 | 1 |
| Solvent | Mineral Spirit | 15 |
| Pigment Dispersant | Disper BYK ® 118 | 2 |
| White Pigment | Ti-Pure ® R-706 | 5 |
| Filler | Ultrex ® 96 | 15 |
| Metal Drier | 12% Co Ten-Cem | 0.1 |
| Metal Drier | 18% Zn Ten-Cem | 0.1 |

Part B

| | | |
|---|---|---|
| Peroxide | Peroxan ® PPIN | 1.8 |
| | Total | 100.00 |

### Example 9

Example 9

| | |
|---|---|
| Component | % |

Part A

| | | |
|---|---|---|
| Polymer | Trilene ® T65 | 80 |
| Co-agent | Ricon ® 156 | 1 |
| Co-agent | SR-350 | 1 |
| Solvent | Mineral Spirit | 8 |
| Metal Drier | 12% Co Ten-Cem | 5 |
| Metal Drier | 18% Zn Ten-Cem | |

Part B

| | | |
|---|---|---|
| Peroxide | Peroxan ® PPIN | 5 |
| | Total | 100.00 |

### Example 10

Example 10

| | |
|---|---|
| Component | % |

Part A

| | | |
|---|---|---|
| Polymer | Trilene ® T65 | 60 |
| Co-agent | Ricon ® 156 | 6 |
| Co-agent | SR-350 | 2 |
| Solvent | Mineral Spirit | 10.5 |
| Pigment Dispersant | Disper BYK ® 118 | 0.1 |
| White Pigment | Ti-Pure ® R-706 | 5 |
| Filler | Ultrex ® 96 | 5 |
| Metal Drier | 12% Co Ten-Cem | 0.7 |
| Metal Drier | 18% Zn Ten-Cem | 0.7 |

Part B

| | | |
|---|---|---|
| Peroxide | Peroxan ® PPIN | 3 |
| Solvent | Mineral Spirit | 7 |
| | Total | 100.00 |

### Example 11: No Metal Drier

Example 11

| | |
|---|---|
| Component | % |

Part A

| | | |
|---|---|---|
| Polymer | Trilene ® T65 | 30 |
| Co-agent | Ricon ® 156 | 1 |
| Co-agent | SR-350 | 1 |
| Solvent | Mineral Spirit | 55 |
| Red Pigment | PGRED001 | 3 |
| Filler | Ultrex ® 96 | 8 |

Part B

| | | |
|---|---|---|
| Curative | Peroxan ® PPIN | 2 |
| | Total | 100.00 |

### Example 12: Low solvent

Example 12

| | |
|---|---|
| Component | % |

Part A

| | | |
|---|---|---|
| Polymer | Trilene ® T65 | 25 |
| Co-agent | Ricon ® 156 | 10 |
| Co-agent | SR-350 | 5 |
| Solvent | Mineral Spirit | 1 |
| Solvent | SIH6115.0 | 6.6 |
| Pigment Dispersant | Disper BYK ® 118 | 5 |
| White Pigment | Ti-Pure ® R-706 | 30 |
| Filler | Ultrex ® 96 | 15 |
| Metal Drier | 12% Co Ten-Cem | 0.2 |
| Metal Drier | 18% Zn Ten-Cem | 0.2 |

Part B

| | | |
|---|---|---|
| Peroxide | Peroxan ® PPO | 2 |
| | Total | 100.00 |

While these embodiments have been described with emphasis on the embodiments, it should be understood that within the scope of the appended claims, the embodiments might be practiced other than as specifically described herein.

What is claimed is:

1. A marine antifouling coating for application to a surface of a marine vessel comprising a hydrophobic polymeric material formed by reacting:
a. a mixture comprising:
(i) at least one ethylene propylene diene terpolymer (EPDM), the terpolymer component having a molecular weight from 1300000 Mw to 5000 Mw, and consisting of:
1. 4 weight percent to 50 weight percent of random covalently linked monomers of ethylene and propylene having weight ratios from 40:60 to 85:15 of ethylene:propylene respectively; and
2. 0.25 weight percent to 15 weight percent of the polymer component is a non-conjugated diene;
(ii) a first co-agent of polybutadiene;
(iii) a second co-agent of an acrylate or methacrylate in a solvent; with
b. at least one peroxide.

2. The marine antifouling coating for application to a surface of a marine vessel of claim 1, wherein the EPDM component is a random terpolymer.

3. A substrate comprising a surface comprising a marine antifouling coating, wherein the marine antifouling coating comprises the hydrophobic polymeric material of claim 1.

4. A maritime vessel comprising the hydrophobic polymeric material of claim 1.

5. A marine antifouling coating that prevents the settlement of marine organisms on a surface and/or prevents the growth of marine organisms on a surface and/or encourages the dislodgement of marine organisms from a surface, the hydrophobic polymeric material comprising:
a. 80 to 99 weight percent of a mixture, wherein the mixture comprises:
(i) 25 weight percent to 80 weight percent of a total amount of the ethylene propylene diene terpolymer (EPDM); the terpolymer component having a molecular weight from 1,300,000 Da to 5000 Da, and consisting of:
1. 4 weight percent to 50 weight percent of random covalently linked monomers of ethylene and propylene having weight ratios from 40:60 to 85:15 of ethylene:propylene respectively; and
2. 0.25 weight percent to 15 weight percent of the polymer component is a non-conjugated diene;
(ii) 1 weight percent to 10 weight percent of a first co-agent based on the total weight of the mixture, the first co-agent comprising polybutadiene, wherein the weight percent of the co-agent is based on a total weight of the mixture, wherein the polybutadiene is a branched or linear polymer having a molecular weight between 1000 and 10000;
(iii) 1 weight percent to 10 weight percent of a second co-agent based on the total weight of the mixture, the second co-agent comprising at least one of:
1. an acrylate co-agent having the molecular formula CH₂═CHCOOH, or having the molecular formula CH₂═CHCOOR, wherein R is an alkyl group; and
2. a methacrylate co-agent having the molecular formula (CH₂═C(CH₃)CO₂H), having the molecular formula CH₂═C(CH₃)CO₂R, wherein R is an alkyl group; and
wherein each second co-agent has at least 2 acrylate groups or at least 2 methacrylate groups; and
(iv) 1.0 weight percent to 55 weight percent of a solvent based on the total weight of the mixture, wherein the solvent comprises at least one of: an aliphatic solvent, an aromatic solvent, and a plant-based solvent, wherein the first and second co-agents chemically bond to the ethylene propylene diene terpolymer (EPDM);
b. 1 weight percent to 5 weight percent of a peroxide based on the total weight of the mixture with the peroxide, the peroxide comprising 30 weight percent to 100 weight percent of a peroxide selected from the group: peroxyketal, a peroxyester, a dialkyl peroxide, a peroxy carbonate, and a hydro peroxide; the mixture and the peroxide when blended form a hydrophobic polymeric marine antifouling coating with a surface energy to prevent the settlement of marine organisms on a surface and/or prevent the growth of marine organisms on a surface and/or encourage the dislodgement of marine organisms from a surface, and with a tensile strength greater than 3.0 MegaPascal, an elongation at break from 50 percent to 200 percent, a surface energy of 18 dyne per centimeter to 30 dyne per centimeter, a scratch resistance that can tolerate 500 grams of weight without surface damage, and an adhesion to metal and epoxy substrates with a lifetime of at least 1 year.

6. The marine antifouling coating of claim 5, further comprising 1 weight percent to 30 weight percent of a pigment based on a total weight of the hydrophobic polymeric material.

7. The marine antifouling coating of claim 5, further comprising 1 weight percent to 30 weight percent of a filler based on a total weight of the hydrophobic polymeric material.

8. The marine antifouling coating of claim 5, further comprising 0.1 weight percent to 5 weight percent of a metal drier based on the total weight of the hydrophobic polymeric material, wherein the metal drier is at least one of: a metal carboxylate and a metal alkoxide.

9. The marine antifouling coating of claim 1, further comprising 0.1 weight percent to 5 weight percent of an adhesion promoter based on the total weight of the hydrophobic polymeric material.

10. The marine antifouling coating of claim 1, further comprising 0.1 weight percent to 5 weight percent of a pigment dispersant based on the total weight of the hydrophobic polymeric material.

11. The marine antifouling coating of claim 1, further comprising 0.1 weight percent to 5 weight percent of an anti-settling agent on the total weight of the hydrophobic polymeric material.

12. The marine antifouling coating of claim 1, further comprising 0.1 weight percent to 5 weight percent of a wetting agent on the total weight of the hydrophobic polymeric material.

13. The marine antifouling coating of claim 1, wherein the solvent is selected from the group: mineral spirits, and hexamethyldi-siloxane.

14. The marine antifouling coating of claim 1, wherein the peroxide is blended with a solvent.
